(19) United States
(12) Patent Application Publication
(10) Pub. No.: US 2021/0223533 A1
(43) Pub. Date: Jul. 22, 2021

(54) SYSTEM AND METHOD FOR DIGITAL MICROSCOPY IMAGING

(71) Applicant: CellaVision AB, Lund (SE)

(72) Inventors: Martin Almers, Lund (SE); Sven Hedlund, Genarp (SE)

(73) Assignee: CellaVision AB, Lund (SE)

(21) Appl. No.: 17/152,604

(22) Filed: Jan. 19, 2021

(30) Foreign Application Priority Data
Jan. 20, 2020 (EP) 20152589.6

(51) Int. Cl. G02B 21/36; G02B 21/24

(52) U.S. Cl. CPC G02B 21/367; G02B 21/244

(57) ABSTRACT

The disclosure relates to a method and corresponding system for digital microscopy imaging comprising: capturing with a camera, a plurality of images of a position in a biological sample, wherein each image is captured at a different focal distance, and determining in the camera, a focus value for each captured image. For each captured image, the focus value of the captured image is compared with at least one threshold focus value. Upon determining that the focus value of the captured image exceeds the at least one threshold focus value, the captured image is marked as an interesting image, and transmitted from the camera to a separate computing unit.

### FIELD OF INVENTION

The invention relates to a system and method for digital microscopy imaging.

### TECHNICAL BACKGROUND

Microscopes have a shallow depth of field, especially when examining objects with high magnification. Thus, for thicker objects, this means that the entire object cannot be in focus at the same time. As a result, the focus has to be adjusted in order to look at one focused part, a so-called focus layer, at a time. In digital microscopy it is sometimes preferable to look at a plurality of focus layers of an object, and in order to do this, the microscope captures images at multiple focus layers throughout the object. These images, each captured at different foci, make up a z-stack in the camera. The z-stack data can then be communicated to external units such as a computer for analysis. The amount of data that needs to be sent to the external unit thus relates to the number of focus layers. Since not all images contain useful or interesting information, this results in vast amounts of unnecessary data being sent to the external unit, which requires high bandwidth and more expensive components. There is thus a need for improvements within this context.

### SUMMARY OF INVENTION

In view of the above, it is thus an object of the present invention to overcome or at least mitigate the problems discussed above. In particular, it is an object of the invention to provide an improved and more efficient way of examining samples with a digital microscope and selecting what image data to send to an external computing unit.

According to a first aspect of the invention, a method is provided for digital microscopy imaging comprising capturing with a camera, a plurality of images of a position in a biological sample, wherein each image is captured at a different focal distance, and then determining in the camera, a focus value for each captured image, and for each captured image, comparing the focus value of the captured image with at least one threshold focus value.

Upon determining that the focus value of the captured image exceeds the at least one threshold focus value, the captured image is marked as an interesting image. Finally, the images marked as interesting are transmitted from the camera to a separate computing unit.

An advantage of this method is that the focus values are determined directly in the camera before the images are sent to a separate computing unit. By doing this, it can be ensured that only relevant images e.g. with good enough quality, i.e. focus value, are sent to the computing unit. Thus, less bandwidth between the camera and the computing unit is required, which allows for a sped up over all analysis process for the sample, as well as a cheaper hardware due to reduced bandwidth requirements.

According to some embodiments of the first part of the first aspect, the step of comparing the focus value of the captured image with at least one threshold focus value comprises comparing the focus value with a first threshold focus value. Advantageously, a low complexity process of determining whether the captured image is relevant or not is achieved.

According to some embodiments of the first part of the first aspect, the method further comprises the step of calculating a focus value curve for the plurality of images, and determining a focal distance corresponding to a peak focus value of the focus value curve, wherein the step of comparing the focus value of the captured image with at least one threshold focus value comprises: for an image captured at a focal distance less than the focal distance corresponding to the peak focus value, comparing the focus value with a first threshold focus value, and for an image captured at a focal distance larger than the focal distance corresponding to the peak focus value, comparing the focus value with a second threshold focus value, the second threshold focus value being different from the first threshold focus value.

An advantage of calculating a focus value curve is that the focus value is a relative measure and cannot be determined by evaluating one isolated image. The focus value curve can then be analyzed in order to select only those images having good enough quality, i.e. focus value. By for example determining a peak focus value of the focus value curve, the focus value of captured images and/or thresholds can be assessed in relation to this peak value. By having a first and second threshold being different from each other and assessing these in relation to e.g. the peak value of the focus value curve, the number of images being marked as interesting can be lowered while still ensuring that all images with interesting information are marked. This can be achieved in thicker or non-uniform samples by having a first threshold that is lower or higher than a second threshold. The first and second threshold can be set based on what type of sample is being analyzed, which thereby increases the flexibility of the inventive concept described herein. For example, the first threshold may be set as a defined percentage of the peak focus value, and the second threshold may be set as defined percentage of the first threshold or the peak focus value.

According to some embodiments of the first part of the first aspect, the steps of comparing the focus value of the captured image with at least one threshold focus value and marking the captured image as an interesting image, is performed in the camera. An advantage of performing the comparing step in the camera is that less data needs to be transferred to an external unit such as a computer. Moreover, the efficiency is increased since the determination of a captured image as being interesting image or not is performed in the camera, thus removing one step of information exchange with an external unit. Thus, less bandwidth is required, and the method gets more efficient.

According to some embodiments of the first part of the first aspect, the method further comprises the step of transmitting, from the camera, each determined focus value to the separate computing unit, wherein the steps of comparing the focus value of the captured image with at least one threshold focus value and marking the captured image as an interesting image is performed at the separate computing unit. The method also further comprises the step of receiving, at the camera, an indication from the separate computing unit of the marked images. An advantage of performing the comparing step in the computer instead of in the camera is that the camera requires less processing power. Moreover, the separate computing unit may use more advanced statistical data and calculations for determining the threshold focus value, without necessarily increasing the requirements of the processing power of the camera.

According to some embodiments of the first part of the first aspect, the step of capturing images is performed for each relevant focal distance in the sample, before the marking of images as interesting images is performed. An advantage of capturing images for each focal distance in the sample is that a more detailed focus value curve can be determined. Thus, the step of marking images as interesting will be more accurate.

According to some embodiments of the first part of the first aspect, the step of determining a focus value is performed after every captured image at each focal distance, before the next image is captured at the next focal distance, such that after a focus value has been determined to exceed the first threshold value, the step of capturing images is interrupted if the determined focus value for a captured image does not exceed the first and/or second threshold value.

An advantage of interrupting the step of capturing images if an image is determined to be of too low quality (i.e. not in focus) is that the analysis process can be sped up.

According to some embodiments of the first part of the first aspect, the first and/or second threshold focus value is calculated as a threshold percentage of the highest determined focus value for the captured images.

An advantage of determining a threshold focus value as a percentage of the highest determined focus value is that it provides for a straightforward way of filtering those images exceeding/not exceeding the percentage threshold. Another advantage of determining a threshold focus value as a percentage of the highest determined focus value is that the threshold is determined based on properties of the biological sample, and thus is individually adapted to each sample.

According to some embodiments of the first part of the first aspect, the threshold percentage for the first threshold is 50%.

According to some embodiments of the first part of the first aspect, the step of capturing images is performed for a plurality of x-y-positions in the sample. An advantage of capturing images for a plurality of x-y-positions is that information from the entire sample is gathered. Thus, the effect of saving bandwidth by only sending interesting images to the external unit becomes even greater, since sending all image information from every z-stack at every x-y-position in a sample would be less efficient and require more time, imply higher requirements on the bus hardware and be more expensive.

According to some embodiments of the first part of the first aspect, the first threshold and/or second threshold is based on focus value curves previously determined for other x-y-positions of the same sample. An advantage of basing thresholds on previously determined focus value curves of the same sample is that a new threshold or thresholds does not have to be determined for every x-y-position within the sample. This saves processing power. Another advantage is that by calculating the first threshold and/or second threshold based on multiple focus curves (e.g. taking the average), the accuracy of the threshold(s) become higher. Another advantage of basing a threshold on previous focus value curves is that the threshold can be set to an advantageous percentage of the peak value.

According to some embodiments of the first part of the first aspect, the focus value for each image is calculated by convolution with a filter in the x-direction and/or y-direction. An advantage of using convolution to filter the images is that it accentuates details of an image that are relevant for determining the focus value.

According to some embodiments of the first part of the first aspect, the camera comprises a programmable logic device, and the step of determining the focal value for the captured images is performed in the programmable logic device. An advantage of using a programmable logic device is that they are small, fast, cheap and requires low power.

According to some embodiments of the first part of the first aspect, the sample is a peripheral blood sample, cytology sample or a histopathology sample.

According to a second part of the first aspect, a system for digital microscopy imaging, comprising is provided: a camera, comprising: a sensor for capturing a plurality of images of a position in a biological sample, wherein each image is captured at a different focal distance, a processing unit for determining a focus value for each captured image, and for each captured image, comparing the focus value of the captured image with at least one threshold focus value, and upon determining that the focus value of the captured image exceeds the at least one threshold focus value, marking the captured image as an interesting image, a transmitting unit for transmitting the focus values and/or the images marked as interesting from the camera, and a separate computing unit, comprising: a receiving unit for receiving the focus values and/or the images marked as interesting from the camera, and a processing unit to assemble the received images.

According to some embodiments of the second part of the first aspect, the processing unit is a programmable logic device.

According to some embodiments of the second part of the first aspect, the camera comprises a camera sensor for capturing a plurality of images of a plurality of x-y-positions in the sample. An advantage of capturing images for a plurality of x-y-positions is that information from the entire sample is gathered. Thus, the effect of saving bandwidth by only sending interesting images to the external unit becomes even greater, since sending all image information from every z-stack at every x-y-position in a sample would be less efficient and require more time, imply higher requirements on the bus hardware and be more expensive.

Preferred embodiments appear in the claims and in the description.

The second part of the first aspect may generally have the same features and advantages as the first part of the first aspect. It is further noted that the invention relates to all possible combinations of features unless explicitly stated otherwise.

### BRIEF DESCRIPTION OF THE DRAWINGS

The invention will by way of example be described in more detail with reference to the appended drawings, which show presently preferred embodiments of the invention. This invention may, however, be embodied in many different forms and should not be construed as limited to the embodiments set forth herein; rather, these embodiments are provided for thoroughness and completeness, and fully convey the scope of the invention to the skilled person. Additionally, variations to the disclosed embodiments can be understood and effected by the skilled person in practicing the claimed invention, from a study of the drawings, the disclosure, and the appended claims. It will be appreciated that the drawings are for illustration only and are not in any way restricting the scope of the invention.

FIG. 1 discloses a schematic view of a method for digital microscopy imaging according to some embodiments of the invention.

FIG. 2 discloses a schematic view of a method for digital microscopy imaging according to some embodiments of the invention.

FIG. 3 discloses a schematic view of a method for digital microscopy imaging according to some embodiments of the invention

FIG. 4a discloses a first example of a focus curve.

FIG. 4b discloses a second example of a focus curve.

FIG. 4c discloses a third example of a focus curve.

FIG. 5 discloses a schematic view of a digital microscopy imaging system according to the invention.

### DETAILED DESCRIPTION OF PREFERRED EMBODIMENTS

It is contemplated that there are numerous modifications of the embodiments described herein, which are still within the scope of the invention as defined by the appended claims. The concept of the present invention is to provide an improved method and system for digital microscopy imaging.

The term relevant, with respect to ‘each relevant focal distance in the sample’, is to be understood as being dependent on the depth of field and content of the slide. Thus, the number of relevant focal distances is not a fixed number, but rather varies with the depth of field and content of the slide.

The z-direction, with respect to e.g. a z-stack, is to be understood as a direction in the vertical plane and representing a depth. The z-direction is perpendicular to both the x- and y-directions, which are perpendicular directions in the horizontal plane.

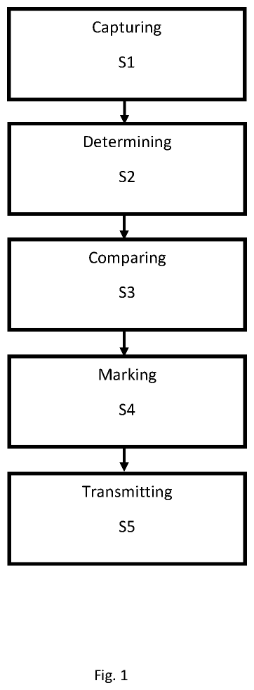

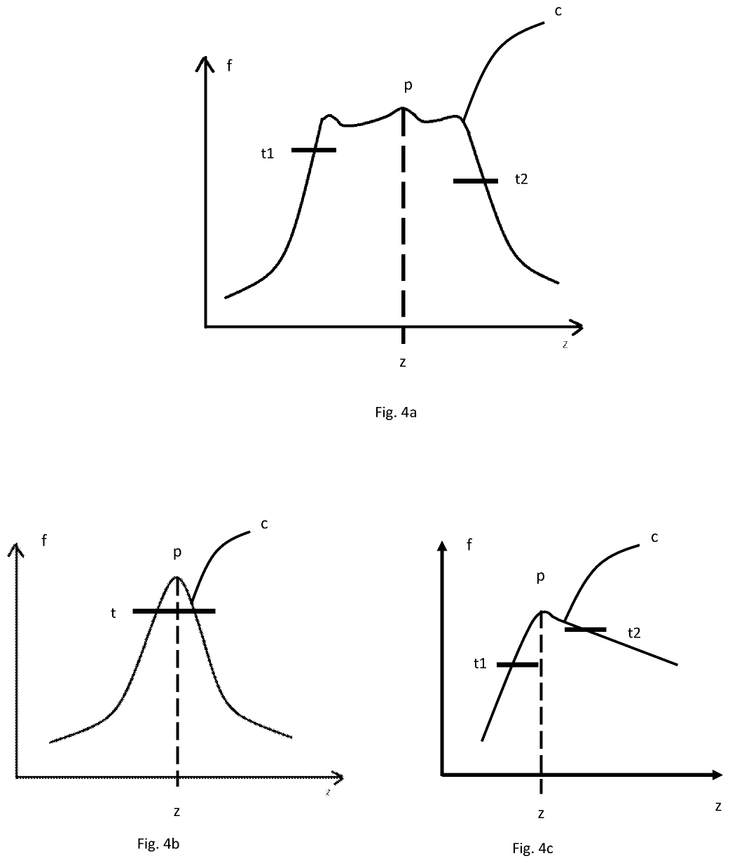

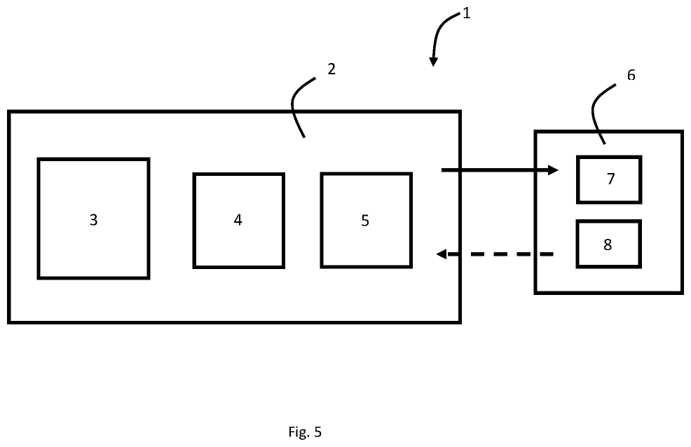

FIG. 1 discloses a schematic view of a method for digital microscopy imaging according to some embodiments of the invention. As can be seen, the method comprises capturing S1 with a camera 2 (further described herein with reference to FIG. 5) a plurality of images of a position in a biological sample. The camera 2 comprises a processing unit 4, and preferably a programmable logic device. The biological sample could be a peripheral blood sample, cytology sample, histopathology sample, cervical sample, bone marrow, fecal sample, or any type of body fluid sample. Each of the images is captured at a different focal distance z (further described herein with reference to FIGS. 4a-c). The camera 2 may capture a plurality of images at a plurality of x-y-positions in the sample. After capturing S1 the images, a focus value f (further described herein with reference to FIGS. 4a-c) is determined S2 for each captured image. The focus value f describes how focused an image is. The focus value can for example be calculated by convoluting the image with a filter in the x- or y-direction. Any other suitable algorithm for determining a focus value of an image may be used, such as performing a contrast measurement on the image data of the image.

For every captured image, the focus value f is then compared S3 with at least one threshold focus value t (further describe herein with reference to FIG. 4). It is plausible that the images are compared S3 to a first threshold focus value t1, and/or a second threshold focus value t2 (further described herein with reference to FIGS. 4a and 4c). If the focus value f of the captured image is determined to exceed the at least one threshold focus value t, the image is marked S4 as interesting. Finally, the images marked as interesting are transmitted S5 from the camera 2 to a separate computing unit 6. Only images marked as interesting are transmitted, which enables for lower requirements on the hardware buses, and speeds up the analysis process, making the system cheaper.

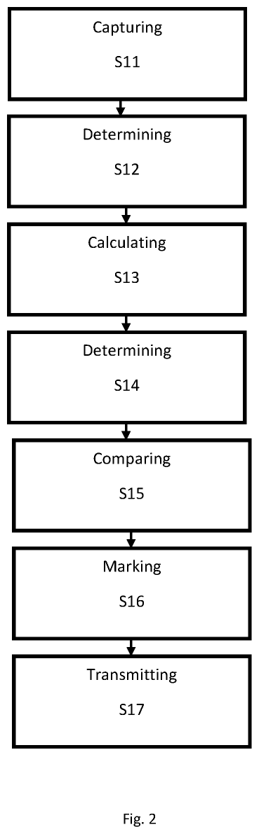

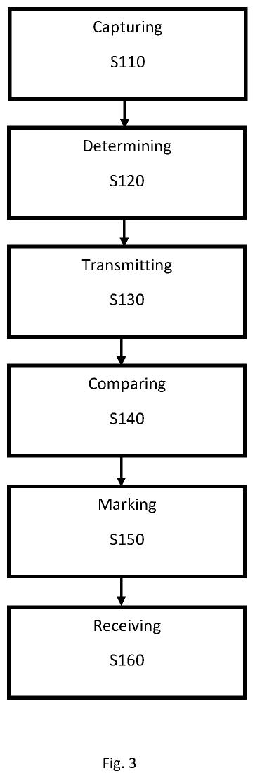

FIG. 2 discloses a schematic view of a method for digital microscopy imaging according to another embodiment of the invention. According to this embodiment, images are captured S11 by a camera 2, and a focus value f for each image is determined S12. Then, a focus value curve c (further described herein with reference to FIGS. 4a-c) is calculated S13 for the plurality of images. By analyzing the focus value curve c, the focus value of captured images and/or thresholds can be assessed in relation to various properties of the curve c. For example, the images and/or thresholds can be assessed in relation to a peak focus value p (further described herein with reference to FIGS. 4a-c). Another example is to apply a low pass filter to the curve c, thereby eliminating noise, and assessing the images and/or thresholds in relation to the resulting filtered curve. Other filters may also be used. In the following sections, examples will be described relating to the peak focus value p, it is however, as just described, possible to evaluate the curve c with respect to other aspects. A focal distance z corresponding to the peak focus value p can be determined S14. For images captured at focal distances z less than the focal distance z determined S14 to correspond to the peak value p, the focus value f is compared 315 with a first threshold focus value t1. For images captured at a focal distance z larger than the focal distance z corresponding to the peak focus value p, the focus value f is compared S15 with a second threshold value t2 that is different from the first threshold focus value f1, The term “different” is to be understood as higher or lower. The first threshold focus value t1 is in some cases lower than the second threshold focus value t2. It is to be noted however, that depending on the direction in which the focus is studied in a sample, the thickness of the sample, or the type of sample, it might be preferable that t2 is lower than t1. It is also plausible that the first and second threshold values are equal. In some cases, the sample is similar in content for every x-y-position. It can therefore be advantageous to base the first t1 and second t2 threshold focus values on focus value curves c previously determined for other x-y-positions of the same sample. The step of comparing images S3, S15 can be performed in the camera 2. As can be seen in FIG. 3, it is however also plausible, that each determined S120 focus value f is transmitted S130 to the separate computing unit 6 from the camera 2. The step of comparing S140 the focus value f of the images to the at least one threshold focus value t and marking S150 them as interesting is then performed in the computing unit 6. An indication is then received S160 at the camera 2 from the computing unit 6 of the marked images. Only the marked images are then transmitted S170 back to the computing unit 6.

For all of the embodiments described herein, it is plausible that the step of capturing images S1, S11, S110 is performed for each focal distance z in the sample before the marking S4, S16, S150 of images as interesting is performed. It is however equally plausible that the focus value f is determined S2, S12, S120 after each image captured S1, S11, S110 at a focal distance z, such that if a focus value f is determined S2, S12, S120 to exceed the first threshold focus value t1, the capturing S1, S11, S110 is interrupted if the determined focus value for a captured image does not exceed the second threshold value t2. The first threshold focus value t1 and/or the second threshold focus value t2, can be calculated as a threshold percentage of the highest determined focus value f for the captured images. The threshold percentage for the first and/or second threshold is for example 50%. It is equally plausible that the percentage is higher such as 55%, 60%, 70%, etc., or lower such as 45%, 40%, 30%, etc.

FIGS. 4a-c show three different examples of focus curves c for a sample. It is to be noted that the number of thresholds, and their placement, in these figures are for explanatory purposes only, and that any type of sample focus curve could have any number of thresholds placed at curve points not illustrated in the figures.

FIG. 4a shows an example of a focus curve c. The focus curve c represented in FIG. 4a could for example be a histopathology sample. These types of samples are often thicker with uneven structures, hence the three peaks seen in the figure. By studying the focus curve c, one can determine which image(s) has a high enough focus value f with respect to a set threshold t1, t2. The x-axis defines the focal distance z at which the image is captured. The y-axis represents the focus value f. The peak focus value p is the highest focus value, and has a corresponding focal distance z. The first threshold t1 and second threshold t2 can be seen in FIG. 4a. In this case, the second threshold t2 is lower than the first threshold t1. For images captured at focal distances z less than the focal distance z determined S14 to correspond to the peak value p, the focus value f can be compared S15 with the first threshold focus value t1. For images captured at a focal distance z larger than the focal distance z corresponding to the peak focus value p, the focus value f can be compared S15 with the second threshold value t2. As can be seen in FIG. 4a, the first threshold t1 is higher than the second threshold t2, however, it is also plausible that it is the other way around as is further described with reference to FIG. 4c.

FIG. 4b shows another example of a focus curve c. The focus curve c in FIG. 4b has a Gaussian shape, which commonly occurs in thinner samples, such as blood. Unlike the example in FIG. 4a, this curve c only has one threshold t. Having multiple thresholds can be advantageous in thicker samples with uneven structures and/or asymmetrical shapes. A second threshold could then be of use to detect irregular behavior such as peaks. In samples where the focus curve c is symmetrical and where different x-y positions have similar properties, a single threshold can be set. If basing the single threshold on previous curves at previous positions in the sample, the estimated threshold can be more statistically accurate, and thus be higher and still ensure that all interesting information (i.e. images with focus values exceeding the threshold) has been added to the z-stack.

FIG. 4c shows yet another example of a focus curve c. As can be seen, the first threshold t1 is lower than the second threshold t2. This is especially useful in embodiments where the thresholds are based on previous focus curves in the same sample. Samples usually look the same for different x-y-positions. Thus, by utilizing previous focus curves in the sample, i.e. knowing roughly where the peak value p should be and which focal distance z has the best image information/focus, the selection of images marked as interesting can be interrupted at t2 despite images to the right in FIG. 4c having a relatively high focus value f. Knowing where the peak value p is, ensures that no important image information gets lost, despite t2 being higher than t1. The realization that the step of marking images as interesting can be interrupted at a second threshold t2 can be utilized irrespective of what the curve c looks like.

FIG. 5 discloses a schematic view of a digital microscopy imaging system 1. The imaging system 1 comprises a camera 2. The camera 2 has a camera sensor 3 which captures images. The camera 2 can capture images of a biological sample at different focal distances z. The camera 2 may capture a plurality of images of a plurality of x-y-positions in the sample. The biological sample could be a peripheral blood sample, cytology sample, histopathology sample, cervical sample, bone marrow, fecal sample, or any type of body fluid sample. The camera 2 can further comprise a processing unit 4. The processing unit determines a focus value f. The focus value f is a relative measurement, and by obtaining a focus curve c one can determine which image is most focused. The focus value f can be determined for each image captured by the camera 2. In the processing unit 4, the focus value f for each captured image can be compared with a threshold focus value t. Should the focus value f of the image be determined to exceed the threshold focus value t, the image is marked as interesting. The camera 2 further comprises a transmitting unit 5 which in some embodiments transmits the focus value f from the camera 2 to a computing unit 6. The transmitting unit 5 transmits the images marked as interesting to the computing unit 6. In FIG. 5, the straight line between the camera 2 and the computing unit 6 represents the communication of the focus values f and/or the images marked as interesting, while the dotted line between the computing unit 6 and the camera 2 represents the communication of the indication of which images are interesting. The computing unit 6, is a separate unit from the camera 2, and may comprise a receiving unit 7. The receiving unit 7 receives the focus value f and/or the images marked as interesting from the camera 2. The computing unit 6 further comprises a processing unit 8, in which the received images from the camera 2 can be assembled. The received images might be assembled into a so-called z-stack. A z-stack consists of multiple images captured at different focus distances z. The user of the digital microscopy system can study the z-stack as if it was a traditional microscope by viewing the different focus depths. It is also plausible that the received images are assembled into one composite image, in which the best focused areas of each image captured at each focal distance z is combined to an “all focused” image. The processing unit 8 might be a programmable logic device.

1. A method for digital microscopy imaging, the method comprising:
capturing with a camera, a plurality of images of a position in a biological sample, wherein each image is captured at a different focal distance,
determining in the camera, a focus value for each captured image,
for each captured image, comparing the focus value of the captured image with at least one threshold focus value;
upon determining that the focus value of the captured image exceeds the at least one threshold focus value, marking the captured image as an interesting image, and
transmitting the images marked as interesting from the camera to a separate computing unit.

2. Method according to claim 1, wherein the step of comparing the focus value of the captured image with at least one threshold focus value comprises comparing the focus value with a first threshold focus value.

3. Method according to claim 1, further comprising the step of:
calculating a focus value curve for the plurality of images,
determining a focal distance corresponding to a peak focus value of the focus value curve,
wherein the step of comparing the focus value of the captured image with at least one threshold focus value comprises:
for an image captured at a focal distance less than the focal distance corresponding to the peak focus value, comparing the focus value with a first threshold focus value,
for an image captured at a focal distance larger than the focal distance corresponding to the peak focus value, comparing the focus value with a second threshold focus value, the second threshold focus value being different from the first threshold focus value.

4. Method according to claim 1, wherein the steps of comparing the focus value of the captured image with at least one threshold focus value and marking the captured image as an interesting image, is performed in the camera.

5. Method according to claim 1, further comprising the step of:
transmitting, from the camera, each determined focus value to the separate computing unit,
wherein the steps of comparing the focus value of the captured image with at least one threshold focus value and marking the captured image as an interesting image is performed at the separate computing unit,
wherein the method further comprises the step of:
receiving, at the camera, an indication from the separate computing unit of the marked images.

6. Method according to claim 1, wherein the step of capturing images is performed for each relevant focal distance in the sample, before the marking of images as interesting images is performed.

7. Method according to claim 2, wherein the step of determining a focus value is performed after every captured image at each focal distance, before the next image is captured at the next focal distance, such that after a focus value has been determined to exceed the first threshold value, the step of capturing images is interrupted if the determined focus value for a captured image does not exceed the first and/or second threshold value.

8. Method according to claim 1, wherein the first and/or second threshold focus value is calculated as a threshold percentage of the highest determined focus value for the captured images.

9. Method according to claim 8, wherein the threshold percentage for the first threshold is 50%.

10. Method according to claim 1, wherein the step of capturing images is performed for a plurality of x-y-positions in the sample.

11. Method according to claim 2, wherein the first threshold and/or second threshold is based on focus value curves previously determined for other x-y-positions of the same sample.

12. Method according to claim 1, wherein the focus value for each image is calculated by convolution with a filter in the x-direction and/or y-direction.

13. Method according to claim 1, wherein the camera comprises a programmable logic device, wherein the step of determining the focal value for the captured images is performed in the programmable logic device.

14. Method according to claim 1, wherein the sample is a peripheral blood sample, cytology sample or a histopathology sample.

15. A system for digital microscopy imaging, comprising:
a camera, comprising:
a camera sensor for capturing a plurality of images of a position in a biological sample, wherein each image is captured at a different focal distance,
a processing unit for determining a focus value for each captured image, and for each captured image, comparing the focus value of the captured image with at least one threshold focus value, and upon determining that the focus value of the captured image exceeds the at least one threshold focus value, marking the captured image as an interesting image,
a transmitting unit for transmitting the focus values and/or the images marked as interesting from the camera, and
a separate computing unit, comprising:
a receiving unit for receiving the focus values and/or the images marked as interesting from the camera, and
a processing unit to assemble the received images.
